(19) United States
(12) Patent Application Publication
(10) Pub. No.: US 2026/0152063 A1
(43) Pub. Date: Jun. 4, 2026

(54) CRAWLER VEHICLE AND CONTROL METHOD TO CONTROL SAID CRAWLER VEHICLE

(71) Applicant: PRINOTH S.P.A., Vipiteno (IT)

(72) Inventors: Martin Kirchmair, Vipiteno (IT); Francesco Salis, Vipiteno (IT); Alberto Paoletti, Vipiteno (IT); Jamie Thom, Vipiteno (IT)

(21) Appl. No.: 19/395,860

(22) Filed: Nov. 20, 2025

(30) Foreign Application Priority Data
Nov. 29, 2024 (IT) 102024000027078
Dec. 18, 2024 (IT) 102024000028929
Feb. 6, 2025 (IT) 102025000002259
Mar. 11, 2025 (IT) 102025000004972
Apr. 11, 2025 (WO) PCT/IB2025/053818
Jun. 6, 2025 (IT) 102025000013255

(51) Int. Cl. B60K 35/22; B60K 35/81; B62D 33/06; E02F 9/26

(52) U.S. Cl. CPC B60K 35/22; B60K 35/81; B62D 33/06; E02F 9/261; B60K 2360/162; B60K 2360/176

(57) ABSTRACT

A crawler vehicle having a frame; at least one working tool which is connected to the frame and is configured to perform a processing of a surface to be worked and a position sensor configured to detect a plurality of positions of the crawler vehicle on the surface to be worked. The crawler vehicle has a control unit configured to reconstruct a trajectory travelled by the crawler vehicle on the surface to be worked as a function of the positions of the crawler vehicle detected by the position sensor and to calculate a reference position to be reached and/or a reference trajectory to be travelled as a function of the positions detected by the position sensor and of the reconstructed trajectory travelled. The crawler vehicle has a display device configured to reproduce a first visual indicator indicative of the calculated reference position and/or of the calculated reference trajectory.

### PRIORITY CLAIM

This application claims the benefit of and priority to Italian Patent Application No. 102024000027078, filed on Nov. 29, 2024, and claims the benefit of and priority to Italian Patent Application No. 102024000028929, filed on Dec. 18, 2024, and claims the benefit of and priority to Italian Patent Application No. 102025000002259, filed on Feb. 6, 2025, and claims the benefit of and priority to Italian Patent Application No. 102025000004972, filed on Mar. 11, 2025, and claims the benefit of and priority to PCT/IB2025/053818, filed on Apr. 11, 2025, and claims the benefit of and priority to Italian Patent Application No. 102025000013255, filed on Jun. 6, 2025, the entire contents of which are each incorporated by reference herein.

### TECHNICAL FIELD

The present disclosure relates to a crawler vehicle, such as a crawler vehicle used for preparing ski runs, and a control method to control the crawler vehicle.

### BACKGROUND

Crawler type vehicles are commonly used along off-road routes to carry out surface processing, such as a preparing the snowpack of ski runs, a cleaning of beaches or operations in the agricultural field.

Generally, the surface to be worked is worked by advancing the crawler vehicle on the surface to be worked and at the same time operating a working tool carried by the crawler vehicle, such as a snow tiller, a snow shovel or a plough. In practice, the crawler vehicle performs a sequence of round trips along the surface to be worked so as to cover and work with the working tool the entire surface to be worked.

In the sector of agricultural operations, to avoid an excessive overlap between two successive passes and at the same time to guarantee the processing of the entire surface to be worked, certain crawler vehicles are equipped with a mechanical tracing device, which is configured to mark a groove along the surface to be worked during the advancement of the crawler vehicle on the surface to be worked to keep track of the portion of surface worked and provide an indication of the trajectory to be followed in the following pass to a driver of the crawler vehicle. Typically, the groove marked on the surface to be worked is aligned with the center of the crawler vehicle when the crawler vehicle makes the next pass in the opposite direction.

In the event that the crawler vehicle is used for the processing of a snowpack, a certain overlap between two successive passes of the working tool is considered the relative best practice to prepare the surface to be worked in an optimal way, thus avoiding leaving unworked portions. However, for drivers with relatively little experience, it is sometimes difficult to drive the crawler vehicle on the surface to be worked so as to work the entire surface to be worked and at the same time minimize the overlap area between two successive passes to avoid working the same portion of the surface twice.

### SUMMARY

An aim of the present disclosure is to realize a crawler vehicle that mitigates certain of the drawbacks of certain of the prior art.

In accordance with certain embodiments of the present disclosure a crawler vehicle is realized, such as a crawler vehicle for preparing ski runs. In these embodiments, the crawler vehicle is configured to advance on a surface to be worked in a travelling direction and comprises a frame extending along a central axis substantially parallel to the travelling direction; a pair of motorized tracks; a driver's cab mounted on the frame; at least one working tool which is connected to the frame and is configured to perform a processing of the surface to be worked during the advancement of the crawler vehicle on the surface to be worked. The crawler vehicle also comprises a position sensor configured to detect a plurality of positions of the crawler vehicle on the surface to be worked during the advancement of the crawler vehicle on the surface to be worked and a control unit which is in communication with the position sensor and is configured to reconstruct a trajectory travelled by the crawler vehicle on the surface to be worked as a function of the positions of the crawler vehicle detected by the position sensor and to calculate a reference position to be reached and/or a reference trajectory to be travelled as a function of the positions detected by the position sensor and of the reconstructed travelled trajectory. The crawler vehicle further includes a display device which is in communication with the control unit and is configured to reproduce a first visual indicator indicative of the calculated reference position and/or the calculated reference trajectory. In accordance with these embodiments of the present disclosure, it is possible to provide the driver of the crawler vehicle with a relatively simple and intuitive visual indication of the optimal reference position to be reached and/or the optimal reference trajectory to be travelled.

In certain embodiments, the control unit is configured to calculate the reference position to be reached and/or the reference trajectory to be travelled so as to guarantee a partial overlap of desired amplitude between two successive passes of the working tool on the surface to be worked.

In practice, it is relatively easy for the driver of the crawler vehicle to cover the entire surface to be worked, while minimizing the overlap area between two successive passes to avoid working the same portion of the surface twice. In this way, it is possible to increase the efficiency of the working operations of the surface to be worked.

In certain embodiments, the display device is configured to reproduce a second visual indicator indicative of a current position of the crawler vehicle on the surface to be worked and/or of a trajectory currently travelled by the crawler vehicle on the surface to be worked. In this way, the driver of the crawler vehicle can view a possible gap between the current position of the crawler vehicle on the surface to be worked and/or the trajectory currently travelled by the crawler vehicle and the reference position to be reached and/or the reference trajectory to be travelled.

In certain embodiments, the control unit is configured to calculate the reference position to be reached and/or the reference trajectory to be travelled as a function of an overall dimension of the at least one working tool on the surface to be worked in a direction substantially transverse to the central axis. In this way, it is possible to control the amplitude of the overlap between two successive passes of the working tool on the surface to be worked to ensure optimal processing of the surface to be worked.

In certain embodiments, the crawler vehicle comprises a detection device which is in communication with the control unit and is configured to detect one or more of operating data comprising operating parameters of the crawler vehicle, information on the operations to be performed and/or information on the characteristics of the environment surrounding the crawler vehicle. In these embodiments, the control unit is configured to calculate the reference position to be reached and/or the reference trajectory to be travelled as a function of the operating data detected by the detection device. In this way, it is possible to calculate the reference position to be reached and/or the reference trajectory to be travelled taking into account the conformation of the environment surrounding the crawler vehicle and the presence of any obstacles.

In certain embodiments, the display device is arranged inside the driver's cab. In more detail, the display device comprises an interface screen configured to display the first visual indicator. In this way, since the interface screen is arranged inside the driver's cab, to reach the reference position and/or follow the reference trajectory, the driver is not forced to look through the windscreen or windows of the driver's cab, which may be relatively dirty or foggy and, consequently, may partially obstruct the driver's view outside the driver's cab.

In certain embodiments, the display device is configured to project the first visual indicator onto the surface to be worked. In more detail, the display device comprises a projector configured to project a light beam onto the surface to be worked so as to reproduce the first visual indicator on the surface to be worked. In this way, the driver of the crawler vehicle can view the reference position and/or the reference trajectory directly on the surface to be worked without the need to look away from the surface to be worked.

A further aim of the present disclosure is to realize a control method to control a crawler vehicle that mitigates certain of the drawbacks of certain of the prior art.

In accordance with certain embodiments of the present disclosure, a control method to control a crawler vehicle is realized. In these embodiments, the control method comprises advancing the crawler vehicle on a surface to be worked in a travelling direction; performing a processing of the surface to be worked by at least one working tool during the advancement of the crawler vehicle on the surface to be worked; detecting a plurality of positions of the crawler vehicle on the surface to be worked during the advancement of the crawler vehicle on the surface to be worked; reconstructing a trajectory travelled by the crawler vehicle on the surface to be worked as a function of the crawler vehicle positions detected; calculating a reference position to be reached and/or a reference trajectory to be travelled as a function of the detected positions and of the reconstructed travelled trajectory; and reproducing a first visual indicator indicative of the calculated reference position and/or of the calculated reference trajectory. In accordance with these embodiments, it is possible to provide the driver of the crawler vehicle with a relatively simple and intuitive visual indication of the optimal reference position to be reached and/or the optimal reference trajectory to be travelled in order to increase the efficiency of the working operations of the surface to be worked.

### BRIEF DESCRIPTION OF THE DRAWINGS

Further characteristics and advantages of the present disclosure will become clear from the following description of non-limiting examples of embodiment thereof, with reference to the figures of the attached drawings, wherein:

FIG. 1 is a view in side elevation, with parts removed for clarity and schematized parts, of a crawler vehicle made in accordance with the present disclosure;

FIG. 2 is a perspective view, with parts removed for clarity and schematized parts, of a detail of the crawler vehicle in FIG. 1; and

FIGS. 3 to 6 are plan views, with parts removed for clarity and schematized parts, of the crawler vehicle of FIG. 1 in respective operating configurations.

### DETAILED DESCRIPTION

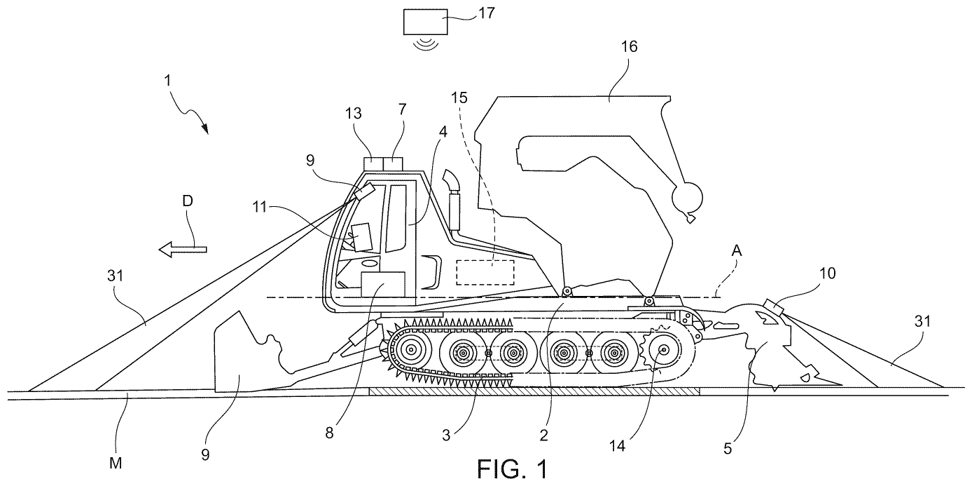

With reference to FIG. 1, number 1 denotes as a whole a crawler vehicle, which in the shown case is used for preparing a snowpack of ski runs. In certain embodiments, the crawler vehicle 1 is a snow groomer. In more detail, the crawler vehicle 1 of these embodiments is used for preparing one or more of downhill ski runs, cross-country ski runs, ski-jumping ramps, half-pipe ski runs, snow-parks and/or snowmobile tracks.

In accordance with a further embodiment, the crawler vehicle 1 can be used for the maintenance of sandy areas, such as beaches, or for agricultural operations, such as one or more of harvesting agricultural products, handling of agricultural products, forage silage, bagasse harvesting and/or bagasse handling.

In addition and in accordance with a further embodiment (not shown in the figures), the crawler vehicle 1 can comprise a shredder, such as a shredder positioned at the front of the crawler vehicle 1, to be used for shredding vegetation.

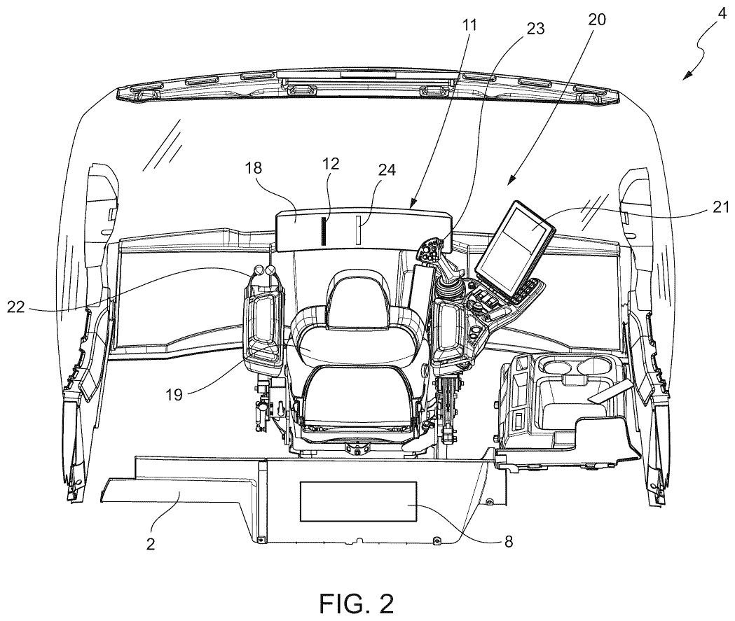

In accordance with certain embodiments of the present disclosure, the crawler vehicle 1 is configured to advance on a surface to be worked M, such as a snowpack, in a travelling direction D. In these embodiments, the crawler vehicle comprises a frame 2 extending along a central axis A substantially parallel to the travelling direction D; a pair of motorized tracks 3 (only one of which is visible in FIG. 1); a driver's cab 4 mounted on the frame 2; and at least one working tool 5, 6 which is connected to the frame 2 and is configured to perform a processing of the surface to be worked M during the advancement of the crawler vehicle 1 on the surface to be worked M. The crawler vehicle also comprises a position sensor 7 configured to detect a plurality of positions of the crawler vehicle 1 on the surface to be worked M during the advancement of the crawler vehicle 1 on the surface to be worked M and a control unit 8 which is in communication with the position sensor 7 and is configured to reconstruct a trajectory travelled by the crawler vehicle 1 on the surface to be worked M based on or as a function of the positions of the crawler vehicle 1 detected by the position sensor 7 and to calculate a reference position to be reached and/or a reference trajectory to be travelled based on or as a function of the positions detected by the position sensor 7 and the reconstructed trajectory travelled. The crawler vehicle also comprises a display device 9, 10, 11 which is in communication with the control unit 8 and is configured to reproduce a visual indicator 12 (see FIGS. 2 to 6) indicative of the calculated reference position and/or of the calculated reference trajectory.

In certain additional embodiments, the crawler vehicle 1 comprises a pair of drive wheels 14 (only one of which is visible in FIG. 1), each of which is coupled to a respective motorized track 3; and a propulsion system 15 (e.g., internal combustion or electric or hydrogen-powered) configured to transmit power to the drive wheels 14.

In the non-limiting embodiment of the present disclosure described and shown, the working tool 5 is mounted at the back on the frame 2 and comprises a snow tiller. The working tool 6 of this embodiment is mounted frontally on the frame 2 and comprises a shovel. It is understood that the crawler vehicle 1 does not necessarily comprise all the working tools 5, 6 mentioned above. For example, the crawler vehicle 1 may comprise one of the working tools 5, 6 or both of the working tools 5 and 6. Furthermore, in the case shown in FIG. 1, the crawler vehicle 1 comprises a winch 16 mounted on the frame 2.

In accordance with an alternative embodiment (not shown in the figures), the working tool 5 can be used for working agricultural fields and can comprise, for example, a plough or a shredder.

In accordance with certain alternative embodiments (not shown in the figures), the working tool 5 and/or the working tool 6 can be used for cleaning sandy areas.

In accordance with certain embodiments, the position sensor 7 comprises a satellite navigation device (e.g., a Global Navigation Satellite System (“GNSS”) type device) which is configured to detect, in real time, the position and three-dimensional orientation of the crawler vehicle 1.

Furthermore, the crawler vehicle 1 of certain embodiments comprises a detection device 13 which is in communication with the control unit 8 and is configured to detect operating data comprising one or more of operating parameters of the crawler vehicle 1, information on the operations to be performed and/or information on the characteristics of the environment surrounding the crawler vehicle 1.

In certain embodiments, the detection device 13 of certain embodiments comprises one or more of a lidar, a radar, an infrared video camera, a stereoscopic camera, a camera and/or a video camera, such as at 270° or 360°. By way of example, in the event that the detection device 13 comprises a camera or a video camera, the detection device 13 is configured to respectively detect images and/or videos of the environment surrounding the crawler vehicle 1.

In accordance with certain embodiments of the present disclosure, the detection device 13 comprises a thermographic camera configured to acquire thermographic images and/or thermographic videos of the environment surrounding the crawler vehicle 1. In certain embodiments, the detection device 13 comprising a thermographic camera that enables one or more of the following to be detected: snow temperature(s); snow humidity; air temperature(s); air humidity; snowpack profile (i.e., based on the temperature difference between snowpack and air); distinguishing a worked surface of snowpack from an unworked surface of snowpack. The use of the thermographic camera is particularly useful in conditions of relative poor visibility, such as at night or in foggy conditions.

In accordance with certain embodiments (not shown in the figures), the detection device 13 can be arranged aboard one or more of other crawler vehicles, recognition vehicles and/or an aerial vehicle, in certain instances unmanned, such as an aerial drone. In certain embodiments, the detection device 13 is arranged in fixed positions on the surface to be worked M and/or at the boundaries of the surface to be worked M.

In accordance with certain embodiments of the present disclosure, the control unit 8 implements artificial intelligence algorithms.

In certain embodiments, the control unit 8 is provided with wireless connection capability (e.g., directly through a local communication network or through a mobile data network and an Internet connection) for connection to a remote monitoring system 17 of a ski resort. In more detail, the remote monitoring system 17 is configured to receive data from the control unit 8, to process the received data, and to monitor and/or control a fleet of crawler vehicles 1 based on or as a function of the processed data. In accordance with certain embodiments, the remote monitoring system 17 implements artificial intelligence algorithms.

In certain embodiments, the control unit 8 is configured to calculate the reference position to be reached and/or the reference trajectory to be travelled based on or as a function of the operating data detected by the detection device 13. In more detail, the control unit 8 is configured to process the operating data detected by the detection device 13 and to identify a position and/or a conformation of reference elements in the environment surrounding the crawler vehicle 1 based on or as a function of the processed data.

In certain embodiments, the control unit 8 is configured to calculate a distance of each reference element identified by the crawler vehicle 1 based on or as a function of the processed data and to calculate the reference position based on or as a function of the calculated distance.

In certain additional or alternative embodiments, the control unit 8 is configured to define an area that can be travelled by the crawler vehicle 1 based on or as a function of the position and/or of the identified conformation of the reference elements and to calculate the reference trajectory based on or as a function of the defined area that can be travelled to avoid collisions with any reference elements classified as obstacles.

In the case described and shown, each of the display devices 9, 10 comprises a respective projector configured to project a light beam onto the surface to be worked M so as to reproduce the visual indicator 12 on the surface to be worked M.

In certain embodiments, the display device 9 is facing in the travelling direction D and is configured to project the light beam to reproduce the visual indicator 12 on a portion of the surface to be worked M that is in front of the driver's cab 4.

In certain embodiments, the display device 10 is facing in a direction opposite to the travelling direction D and is configured to project the light beam to reproduce the visual indicator 12 on a portion of the surface to be worked M that is behind the crawler vehicle 1.

In certain additional or alternative embodiments, the display device 11 is arranged inside the driver's cab 4 and comprises an interface screen 18 configured to display the visual indicator 12.

It is understood that the crawler vehicle 1 does not necessarily comprise all the display devices 9, 10, 11 mentioned above. For example, the crawler vehicle 1 may comprise one or two of the display devices 9, 10, 11. By way of example, in accordance with an alternative embodiment, the crawler vehicle 1 comprises the display devices 9 and 10 and is without the display device 11. In accordance with certain further alternative embodiments, the crawler vehicle 1 comprises the display device 11 and is without the display devices 9 and 10.

With reference to FIG. 2, the crawler vehicle 1 of certain embodiments comprises a seat 19 arranged inside the driver's cab 4, such as in front of the interface screen 18, and a control interface 20 which is in communication with the control unit 8 and is configured to receive commands from the driver of the crawler vehicle 1 and to transmit the commands to the control unit 8. In certain embodiments, the control interface 20 is arranged in proximity of the seat 19 so as to be within reach of the driver of the crawler vehicle 1 when the driver is seated on the seat 19.

In the non-limiting embodiment of the present disclosure described and shown, the control interface 20 comprises a control screen 21 provided with a touch sensor configured to detect a touch and/or a tap, a control lever 22, and a joystick 23. In practice, the control interface 20 enables the driver to control the movement of the crawler vehicle 1 and the operation of the working tools 5, 6. In certain embodiments, the control lever 22 and the joystick 23 are configured to drive the advancement of the crawler vehicle 1 and to control the movements of the working tools 5, 6.

With reference to FIGS. 2 to 6, each display device 9, 10, 11 of certain embodiments is configured to reproduce a visual indicator 24 indicative of a current position of the crawler vehicle 1 on the surface to be worked M and/or of a trajectory currently travelled by the crawler vehicle 1 on the surface to be worked M.

In certain embodiments, each display device 9, 10, 11 is configured to reproduce the visual indicator 24 aligned with the central axis A of the frame 2. In more detail, each display device 9, 10, 11 is configured to simultaneously reproduce the visual indicators 12 and 24 such as by using different colorings.

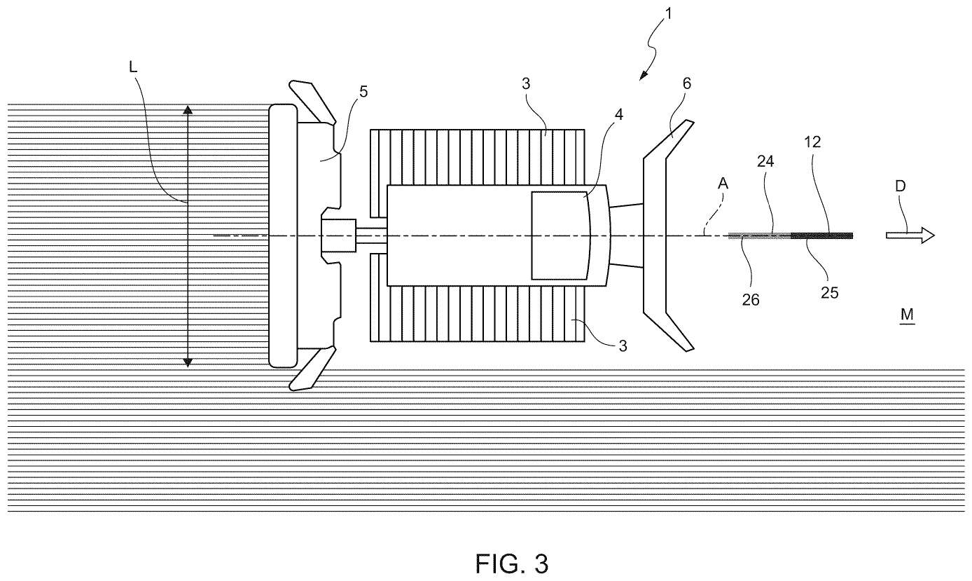

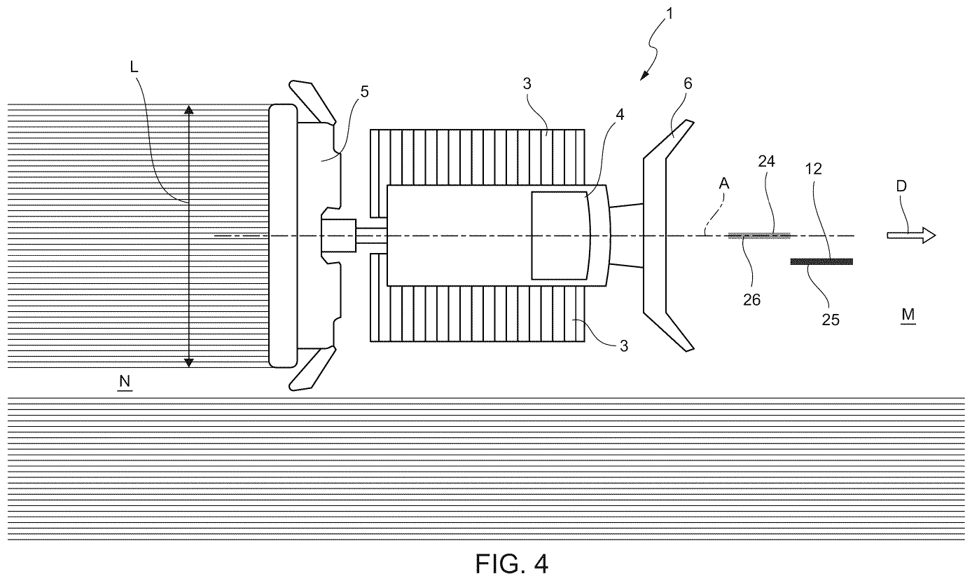

With reference to FIGS. 3 and 4, the control unit 8 of certain embodiments is configured to calculate the reference position to be reached and/or the reference trajectory to be travelled based on or as a function of an overall dimension L of the working tool 5 on the surface to be worked M in a direction substantially transverse to the central axis A.

In use, in the configuration described and shown, the crawler vehicle 1 advances in the travelling direction D and the display device 9 projects the light beam to reproduce the visual indicator 12 and the visual indicator 24 on a portion of the work surface M that is in front of the driver's cab 4.

In certain embodiments, the visual indicator 12 comprises a linear element 25 extending in a direction substantially parallel to the central axis A and the visual indicator 24 comprises a linear element 26 extending in a direction substantially parallel to the central axis A. In more detail, in the operating configuration of FIG. 3, the linear element 25 is aligned with the linear element 26 and the crawler vehicle 1 advances on the surface to be worked M following the reference trajectory. In such a configuration, the crawler vehicle 1 advances without leaving on the surface to be worked M unworked portions between one pass and the other.

In the operating configuration of FIG. 4, the linear element 25 is offset with respect to the linear element 26 and the crawler vehicle 1 advances on the surface to be worked M deviating from the reference trajectory. In such a configuration, the crawler vehicle 1 advances leaving on the surface to be worked M an unworked portion N between one pass and the other.

It is understood that the visual indicators 12 and 24 may comprise visual elements other than the linear elements 25 and 26. By way of example, the visual indicators 12 and 24 may comprise one or more of respective dotted visual elements, respective dashed visual elements, respective curved visual elements and/or respective arrow visual elements.

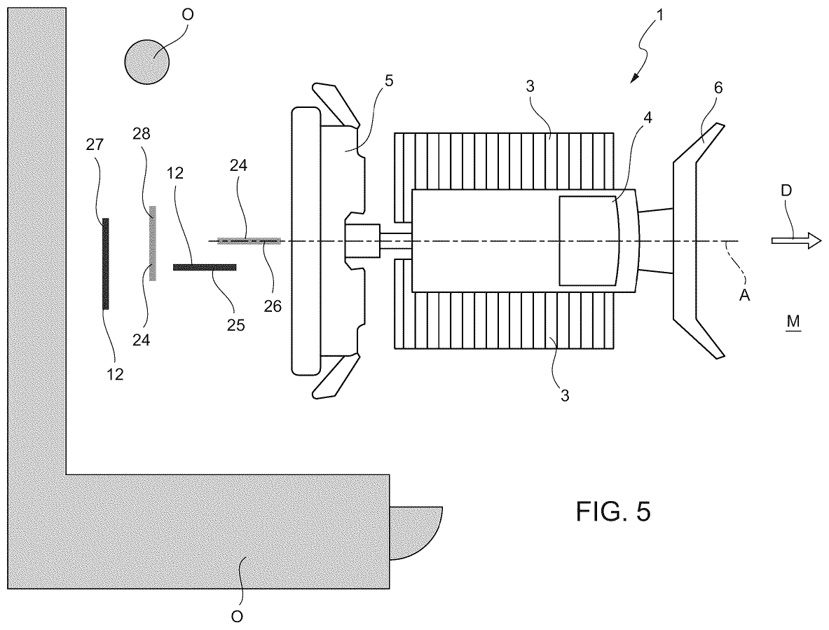

In use and with reference to FIG. 5, the crawler vehicle 1 advances in a direction opposite to the travelling direction D, in particular in reverse, and the display device 10 projects the light beam to reproduce the visual indicator 12 and the visual indicator 24 on a portion of the surface to be worked M that is behind the crawler vehicle 1.

In certain embodiments, the visual indicator 12 comprises a linear element 27 extending in a direction transverse to the central axis A and the visual indicator 24 comprises a linear element 28 extending in a direction transverse to the central axis A.

In the operating configuration described and shown, the visual indicator 12 is indicative of the reference position to be reached calculated by the control unit 8. In more detail, the calculated reference position takes into account the obstacles O present on the surface to be worked M and, in certain embodiments, corresponds to a stop position for the crawler vehicle 1 calculated to avoid risks of collision with the obstacles O. The visual indicator 24 is indicative of the current position of the crawler vehicle 1 with respect to the calculated reference position.

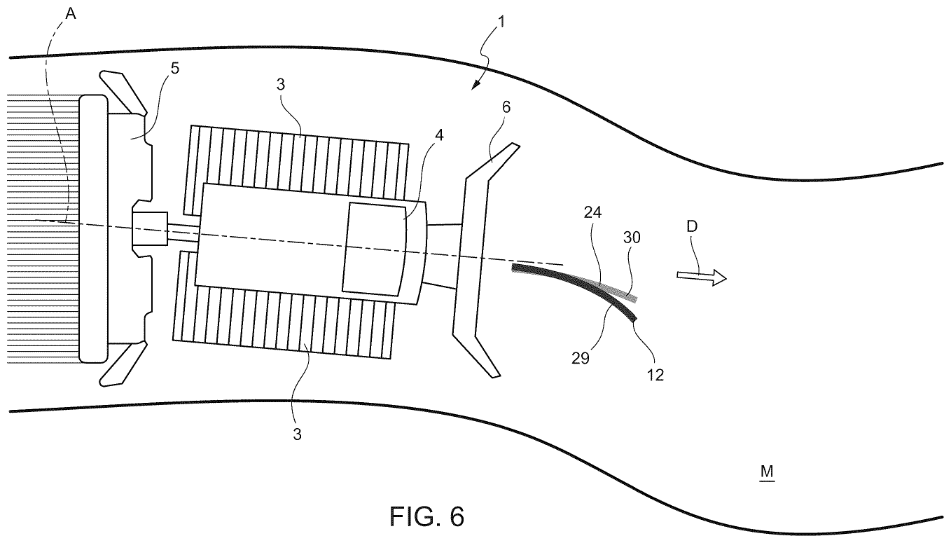

In use and with reference to FIG. 6, the crawler vehicle 1 advances in the travelling direction D and the display device 9 projects the light beam to reproduce the visual indicator 12 and the visual indicator 24 on a portion of the surface to be worked M that is in front of the driver's cab 4.

In certain embodiments, the visual indicator 12 comprises a curved element 29 indicative of the reference trajectory to be travelled and the visual indicator 24 comprises a curved element 30 indicative of the trajectory currently travelled by the crawler vehicle 1 on the surface to be worked M.

From an operating point of view, the crawler vehicle 1 can be used in one or more of the following operating modes: a first fully autonomous operating mode in which the control unit 8 calculates the reference position to be reached and/or the reference trajectory to be travelled and controls the crawler vehicle 1 so that it reaches the reference position and/or travels the reference trajectory; and a second partially assisted operating mode in which the advancement of the crawler vehicle 1 is controlled by a driver assisted by the visual indicators 12 and 24 reproduced by the display devices 9, 10, 11.

It is evident that variants can be made to the present disclosure without, however, departing from the scope of protection of the appended claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

1. A crawler vehicle configured to advance on a surface to be worked in a travelling direction, the crawler vehicle comprising:
a frame extending along a central axis substantially parallel to the travelling direction;
a pair of motorized tracks;
a driver cab mounted on the frame;
a working tool connected to the frame and configured to perform a processing of the surface to be worked during an advancement of the crawler vehicle on the surface to be worked;
a position sensor configured to detect a plurality of positions of the crawler vehicle on the surface to be worked during the advancement of the crawler vehicle on the surface to be worked;
a control unit in communication with the position sensor and configured to: reconstruct a trajectory travelled by the crawler vehicle on the surface to be worked based on the positions of the crawler vehicle detected by the position sensor and calculate, based on the positions detected by the position sensor and the reconstructed trajectory, at least one of a reference position to be reached and a reference trajectory to be travelled; and
a display device in communication with the control unit and configured to reproduce a first visual indicator indicative of the at least one of the calculated reference position to be reached and the calculated reference trajectory to be travelled.

2. The crawler vehicle of claim 1, wherein the display device is configured to reproduce a second visual indicator indicative of at least one of a current position of the crawler vehicle on the surface to be worked and a trajectory currently being travelled by the crawler vehicle on the surface to be worked.

3. The crawler vehicle of claim 2, wherein the display device is configured to reproduce the second visual indicator aligned with the central axis.

4. The crawler vehicle of claim 2, wherein at least one of the first visual indicator and the second visual indicator comprises a first linear element extending in a direction substantially parallel to the central axis, and a second linear element extending in a direction transverse to the central axis.

5. The crawler vehicle of claim 1, wherein the control unit is configured to calculate the at least one of the reference position to be reached and the reference trajectory to be travelled based on an overall dimension of the working tool on the surface to be worked in a direction substantially transverse to the central axis.

6. The crawler vehicle of claim 1, further comprising a detection device in communication with the control unit and configured to detect operating data comprising at least one of operating parameters of the crawler vehicle, information on an operation to be performed and information on a characteristic of an environment surrounding the crawler vehicle, wherein the control unit is configured to calculate the at least one of the reference position to be reached and the reference trajectory to be travelled based on the operating data detected by the detection device.

7. The crawler vehicle of claim 1, wherein the display device is arranged inside the driver cab.

8. The crawler vehicle of claim 7, wherein the display device comprises an interface screen configured to display the first visual indicator on the interface screen.

9. The crawler vehicle of claim 1, wherein the display device is configured to project the first visual indicator onto the surface to be worked.

10. The crawler vehicle of claim 9, wherein the display device comprises a projector configured to project a light beam onto the surface to be worked to reproduce the first visual indicator onto the surface to be worked.

11. A method of controlling a crawler vehicle, the method comprising:
advancing the crawler vehicle on a surface to be worked in a travelling direction;
performing, by a working tool of the crawler vehicle, a processing of the surface to be worked during the advancement of the crawler vehicle on the surface to be worked;
detecting a plurality of positions of the crawler vehicle on the surface to be worked during the advancement of the crawler vehicle on the surface to be worked;
reconstructing, based on the detected positions, a trajectory travelled by the crawler vehicle on the surface to be worked;
calculating, based on the detected positions and the reconstructed trajectory, at least one of a reference position to be reached and a reference trajectory to be travelled ; and
reproducing a first visual indicator indicative of the at least one of the calculated reference position to be reached and the calculated reference trajectory to be travelled.

12. The method of claim 11, further comprising reproducing a second visual indicator indicative of at least one of a current position of the crawler vehicle on the surface to be worked and a trajectory currently being travelled by the crawler vehicle on the surface to be worked.

13. The method of claim 11, further comprising calculating the at least one of the reference position to be reached and the reference trajectory to be travelled based on an overall dimension of the working tool on the surface to be worked in a direction substantially transverse to a central axis that a frame of the crawler vehicle extends along.

14. The method of claim 11, further comprising:
detecting operating data comprising at least one of an operating parameter of the crawler vehicle, information on an operation to be performed, and information on a characteristic of an environment surrounding the crawler vehicle, and
calculating the at least one of the reference position to be reached and the reference trajectory to be travelled based on the detected operating data.

15. The method of claim 11, further comprising reproducing the first visual indicator on an interface screen arranged inside a driver cab of the crawler vehicle.

16. The method of claim 11, further comprising projecting the first visual indicator onto the surface to be worked.
